(19) United States
(12) Patent Application Publication
(10) Pub. No.: US 2006/0116060 A1
(43) Pub. Date: Jun. 1, 2006

(54) Holder plate supporting grinding elements

(75) Inventor: Hakan Thysell, Soderkoping (SE)

Correspondence Address: MERCHANT & GOULD PC, P.O. BOX 2903, MINNEAPOLIS, MN, 55402-0903, US

(73) Assignee: HTC Sweden AB, Soderkoping (SE)

(21) Appl. No.: 11/288,661

(22) Filed: Nov. 28, 2005

Related U.S. Application Data
(60) Provisional application No. 60/631,178, filed on Nov. 29, 2004.

(30) Foreign Application Priority Data
Nov. 29, 2004 (SE) 0402895-7

(51) Int. Cl. B23F 21/03

(52) U.S. Cl. 451/548

(57) ABSTRACT

A holder plate supporting grinding elements for grinding and/or polishing hard floor surfaces of stone, concrete, terrazzo or similar, has an element for mounting this on a driven grinding plate that rotates flat substantially parallel with the floor surface. The holder plate carries at least two grinding elements where each of the grinding elements has the shape of a geometric body which is defined by two substantially parallel base surfaces spaced apart from each other and at least one side surface extending between the edges of the base surface. The base surfaces are substantially parallel with the holder plate and substantially oblong. The grinding element is arranged on the holder plate so that when the holder plate is mounted on the grinding plate, a longitudinal direction of the base surface concerned is substantially parallel with a tangent on the grinding plate.

### TECHNICAL FIELD

The present invention relates to a holder plate supporting grinding elements for grinding and/or polishing of hard floor surfaces such as stone, concrete, terrazzo or similar.

### BACKGROUND

Holder plates supporting grinding elements are known from EP-1 321 233 or from PCT/SE2004/000905. A multiplicity, normally at least three, such holder plates supporting grinding elements are mounted on a driven grinding plate (FIG. 2) that rotates flat, substantially parallel with the floor surface, which plate is in turn mounted in a grinding machine of for example the type shown in W002/062524 or EP-0 700 327. The grinding plate with the holder plate with grinding elements mounted is thus brought into contact with the floor surface, where the grinding plate is rotated and the floor surface ground and/or polished.

In applications where only grinding and/or polishing grinding elements are used, normally at least two circular or rectangular grinding elements are arranged on the holder plate. With rectangular grinding elements, the one grinding element is normally arranged substantially parallel with the tangent of the grinding plate and the other grinding element is normally set at an angle to the first as illustrated in FIG. 1. This known arrangement of grinding elements is motivated by a desire to drive the removed material out towards the periphery of the grinding plate.

One problem with known holder plates for grinding elements is that unevenness and protrusions on the floor surface and removed material located on the floor surface cause varying and sometimes great stresses on the grinding element which can lead to its cracking, crushing or breaking from the holder plate.

### SUMMARY OF THE INVENTION

One object of the present invention is to achieve an improved or alternative holder plate supporting a grinding element.

This object is achieved fully or partly with a holder plate supporting a grinding element according to the enclosed independent claim. Embodiments arise from the enclosed independent claim and from the following description and drawings.

Thus a holder plate supporting a grinding element is achieved for grinding and/or polishing of hard floor surfaces of stone, concrete, terrazzo or similar. The holder plate has elements for mounting this on a driven grinding plate that rotates flat, substantially parallel to the floor surface. The grinding plate supports at least two grinding elements, where each of the grinding elements has the form of a geometric body which is defined by two substantially parallel base surfaces spaced apart from each other and at least one side surface extending between the edges of the base surfaces. The base surfaces are substantially parallel with the holder plate and substantially oblong. The grinding elements are arranged on the holder plate so that when the holder plate is mounted on the grinding plate, a longitudinal direction of the base surface concerned is substantially parallel with a tangent of the grinding plate located at the grinding element.

The term “grinding element” refers to an element with a grinding and/or polishing effect. Such elements can comprise a matrix of metal or plastics resin which contain grinding particles of any size and any material, for example a grinding agent such as PCD and/or diamond.

The term “for grinding and/or polishing” here refers to a holder plate with only a grinding and/or polishing element and hence not holder plates which have one or more cutting edges for cutting of floor surfaces.

The “mounting element” is an arrangement which can be used to attach the holder plate to the grinding disc. Examples of such elements can be threaded holes for fastening the holder plate to the grinding disc by means of screws as shown in EP-1 321 233. Another example of such an element can be the surrounding flanges as shown in PCT/SE2004/000905.

The reference to the base surfaces being substantially oblong means that each of the base surfaces has a longitudinal direction and a transverse direction substantially orthogonal in relation thereto, such that the extent of the base surface is longer in the longitudinal direction than in the transverse direction. The grinding elements are thus arranged on the holder plate so that the longitudinal direction of their respective base surfaces is substantially parallel to a tangent on the grinding plate.

The term “substantially parallel to a tangent” includes a degree of angular deviation from the tangent for example so that the longitudinal directions of the grinding elements can be parallel with each other. In practice this can mean a relatively small deviation from the tangent as the grinding plate and in particular its radius is relatively large compared with the grinding elements.

By arranging the grinding element in accordance with the invention, a reduced sensitivity is achieved to removed material located on the floor surface since the grinding element has a smaller area affected by such removed material. By arranging the grinding element with its longitudinal direction parallel to the tangent, the holder plate itself is made stiffer, reducing the risk of this falling away from the grinding plate when such assembly elements as shown in PCT/SE2004/000905 are used. Also a more even flow of coolant is achieved in applications where coolant is utilised.

The base surface can taper in a first direction parallel to the tangent. By tapering the base surface in the direction of the tangent, a plough effect is achieved which means that removed material located on the floor surface is eliminated, hence reducing the force which this exerts on the grinding element.

The base surface can taper in a second direction opposite the first. By tapering the base surface in the opposite direction, the grinding element can be rotated in either direction i.e. clockwise or counter-clockwise.

According to one embodiment the base surface at its one end in the longitudinal direction has a tip pointing in the longitudinal direction. Because the base surface has a tip, an improved scraping effect is achieved which is advantageous when for example paint residue or similar remains on and should be removed from the floor surface.

According to another embodiment the base surface is rounded at its one end in the longitudinal direction. Because the base surface is rounded there is less risk that scratches will occur on the floor surface.

The embodiments will now be described in more detail with reference to the enclosed drawings.

### BRIEF DESCRIPTION OF THE DRAWINGS

FIG. 1 shows a diagrammatic plan view of a holder plate supporting grinding elements according to the prior art.

FIG. 2 shows a diagrammatic plan view of a grinding disc on which are arranged three holder plates according to FIG. 1.

FIG. 3 shows a diagrammatic plan view of a holder plate supporting a grinding element according to one embodiment of the present invention.

FIGS. 4a-4g show diagrammatic plan views of the grinding element according to alternative embodiments of the present invention

FIG. 5 is a diagrammatic perspective view of the grinding element in FIG. 4a.

### DESCRIPTION OF EMBODIMENTS

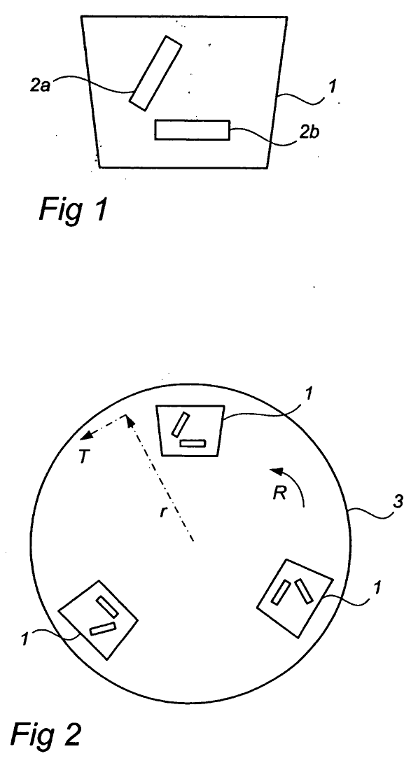

FIG. 1 shows a known holder plate 1 supporting grinding elements which is fitted with two grinding elements 2a, 2b arranged in the traditional manner.

FIG. 2 shows a known grinding plate 3 on which are arranged three holder plates 1 supporting grinding elements. It can be seen that the number of holder plates 1 arranged on the grinding plate can vary as required. Normal configurations comprise 3-6 holder plates 1.

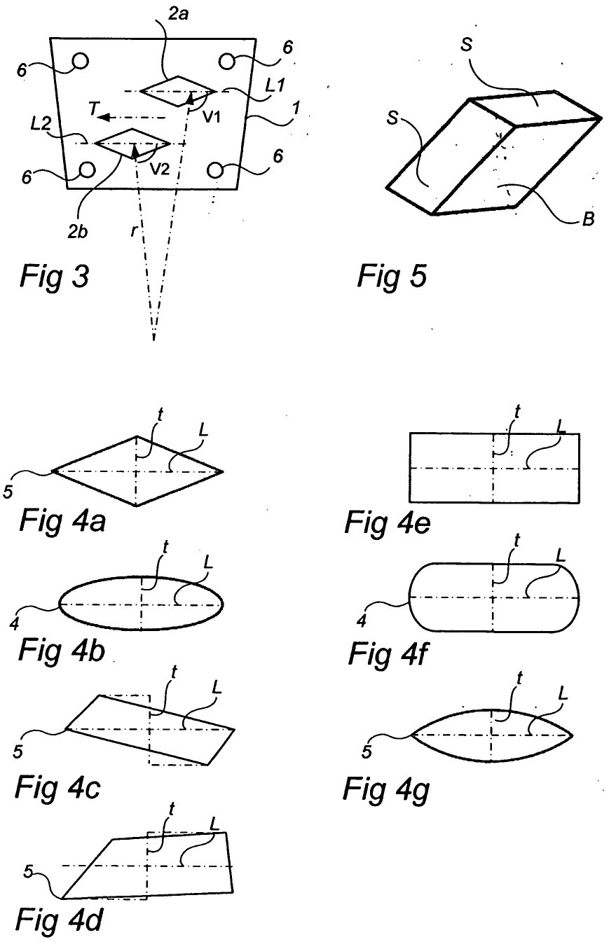

FIG. 3 shows a holder plate 1 supporting grinding elements according to the invention. On the holder plate 1 are arranged two grinding elements 2a, 2b in such a way that their respective longitudinal direction L is substantially parallel to a tangent on the grinding plate 3 on which the holder plate 1 is to be arranged. According to one embodiment therefore the angles V₁ and V₂ between the longitudinal directions L₁, L₂ of the respective grinding elements 2a, 2b, and the radius r of the grinding plate are essentially equally large but they can also deviate slightly from each other for example so that the longitudinal directions L₁, L₂ of the grinding elements 2a, 2b are parallel to each other.

The grinding element has the form of a three-dimensional body which is defined by two substantially parallel base surfaces B (FIG. 5) and side surfaces S extending between the opposing edges of the base surfaces (FIG. 5).

FIGS. 4a-4g show for example embodiments of geometries of the base surface. As shown in FIGS. 4a-4g, the grinding elements can be considered oblong as they have a respective length L which is greater than their respective with t.

According to one embodiment all base surfaces B of the grinding element (FIG. 5) are substantially similar. According to a first variant of this embodiment the base surfaces are substantially of the same size. According to a second variant of these embodiments the base surfaces comprise a first base surface located nearest the holder plate and a second base surface located remote from the holder plate, where the first base surface has a larger area than the second. The grinding element thus tapers from the holder plate 1 and downwards towards the floor surface to be ground. According to a third variant of this embodiment the base surfaces comprise a first base surface located nearest the holder plate and a second base surface located remote from the holder plate, where the first base surface has a smaller area than the second.

As shown from FIGS. 4a-4d and 4f-4g, the base surface can taper in a first direction parallel to the tangent but also in a second direction opposite the first.

As shown by FIG. 4b and FIG. 4f, the distal end of the base surface in the longitudinal direction L can have a rounding 4. Alternatively as shown in FIGS. 4a and 4c-4d and 4g, the base surface can have a tip 5 pointing in the longitudinal direction.

It can be seen that the holder plate 1 according to the present invention can be fitted with an arbitrary number of grinding elements for example 1, 2, 3, 4, 5 or 6, depending on requirements and the space available on the holder plate 1.

1. Holder plate supporting grinding elements for grinding and/or polishing hard floor surfaces as stone, concrete, terrazzo or similar,
which holder plate has an element for mounting on a driven grinding plate that rotates flat, substantially parallel with the floor surface,
which holder plate carries at least two grinding elements,
where each of the grinding elements has the form of a geometric body defined by two substantially parallel base surfaces spaced apart from each other and at least one side surface extending between the edges of the base surfaces,
where the base surfaces are substantially parallel to the holder plate and
where the base surfaces are substantially oblong,
wherein,
the grinding element is arranged on the holder plate so that when the holder plate is mounted on the grinding plate, a longitudinal direction of the base surface concerned is substantially parallel with a tangent of the grinding plate located at the grinding element.

2. Holder plate according to claim 1, where the base surface tapers in a first direction parallel to the tangent.

3. Holder plate according to claim 2, where the base surface tapers in a second direction opposite the first.

4. Holder plate according to claim 1, where the base surface at its one end in the longitudinal direction has a tip pointing in the longitudinal direction.

5. Holding plate according to claim 1, where the base surface is rounded at its one end in the longitudinal direction.
